(19) United States
(12) Patent Application Publication
(10) Pub. No.: US 2018/0080366 A1
(43) Pub. Date: Mar. 22, 2018

(54) Cooling System for Internal Combustion Engine, and Control Method Thereof

(71) Applicant: Hitachi Automotive Systems, Ltd., Hitachinaka-shi, Ibaraki (JP)

(72) Inventors: Yuichi TOYAMA, Isesaki-shi (JP); Atsushi MURAI, Isesaki-shi (JP); Shigeyuki SAKAGUCHI, Isesaki-shi (JP)

(21) Appl. No.: 15/563,654

(22) PCT Filed: Mar. 29, 2016
(86) PCT No.: PCT/JP2016/060243

§ 371 Date: Oct. 2, 2017

(30) Foreign Application Priority Data
Apr. 3, 2015 (JP) 2015-077095

(51) Int. Cl. F01P 3/20; F01P 7/16; F01M 5/02; F01P 5/12; F16H 57/04

(52) U.S. Cl. CPC F01P 3/20; F01P 7/16; F01P 2007/146; F01P 5/12; F16H 57/0412; F01M 5/021

(57) ABSTRACT

The present invention provides a cooling system for an internal combustion engine, comprising: a flow channel switching valve for switching between a plurality of cooling water channels at least including a heater line for air heating, a block line for cooling an engine block, and a transmission line for an oil warmer of a transmission so as to sequentially open at least one of the plurality of cooling water channels in accordance with a warm-up state of the internal combustion engine; and a control device for controlling opening and closing of the flow channel switching valve so as to restrict a cooling water distribution rate of the heater line. The cooling system allows acceleration of cooling water temperature recovery from a temporary drop.

### TECHNICAL FIELD

The present invention relates to a cooling system for an internal combustion engine, and in particular, relates to a cooling system for an internal combustion engine capable of accelerating temperature increase of cooling water, and relates to a control method thereof.

### BACKGROUND ART

A conventional cooling system of this type includes two cooling water channels and a valve for adjusting cooling water flow rates through these two cooling water channels. Through one of the cooling water channels, cooling water flows sequentially by way of a heat exchanger for air heating and a heat exchanger for transmission oil. The other one of the cooling water channels, which is provided separately from the above cooling water channel, includes a bypass passage. The valve is disposed at a point where the cooling water having passed the oil heat exchanger meets the cooling water having passed through the bypass passage. Such a conventional cooling system measures at least either of the vehicle interior temperature and the vehicle exterior temperature as well as the temperature of cooling water discharged from the engine, and controls the actuation of the valve so as to switch between these two cooling water channels when these temperature measurements satisfy their respective predetermined conditions (see Patent Document 1, for example).

### REFERENCE DOCUMENT LIST

### Patent Document

Patent Document 1: JP 4994546 B

### SUMMARY OF THE INVENTION

### Problems to be Solved by the Invention

However, in such a conventional cooling system, when the valve is actuated so as to open the cooling water channel routed by way of the heat exchanger for air heating, the heat exchanger for air heating removes heat from the cooling water that flows through the cooling water channel. This temporarily slows down the temperature increase of cooling water, thus prolonging the time required to increase the engine oil temperature to a desired level. As a result, engine friction increases and fuel efficiency deteriorates, which are problematic.

To address the above problems, the present invention has been made to provide a cooling system for an internal combustion engine capable of accelerating temperature increase of cooling water, and a control method thereof.

### Means for Solving the Problems

To achieve the above object, a cooling system for an internal combustion engine according to the present invention comprises: a flow channel switching valve for switching between a plurality of cooling water channels at least including a heater line for air heating, a block line for cooling an engine block, and a transmission line for an oil warmer of a transmission so as to sequentially open at least one of the plurality of cooling water channels in accordance with a warm-up state of the internal combustion engine; and a control device for controlling opening and closing of the flow channel switching valve so as to restrict a cooling water distribution rate of the heater line.

In a method for controlling a cooling system according to the present invention, in which the cooling system includes a flow channel switching valve for switching between a plurality of cooling water channels at least including a heater line for air heating, a block line for cooling an engine block, and a transmission line for an oil warmer of a transmission so as to sequentially open at least one of the plurality of cooling water channels in accordance with a warm-up state of the internal combustion engine; and a control device, the control device is caused to control opening and closing of the flow channel switching valve so as to control cooling water distribution rates of the plurality of cooling water channels. In this method, the control device controls the opening and closing of the flow channel switching valve so as to restrict a cooling water distribution rate of the heater line.

### Effects of the Invention

According to the present invention, even when the heater line opens and the temperature increase of cooling water temporarily slows down due to heat removal from cooling water by the heat exchanger for air heating, it is possible to accelerate temperature increase of cooling water, thus reducing engine friction.

### BRIEF DESCRIPTION OF THE DRAWINGS

FIG. 1 is a schematic configuration diagram illustrating a cooling system for an internal combustion engine according to an embodiment of the present invention.

FIG. 2 is a flowchart illustrating how to determine operation conditions of the cooling system.

FIG. 3 illustrates the operation of a flow channel switching valve of the cooling system.

FIG. 4 illustrates a cooling water circulation route immediately after engine start.

FIG. 5 illustrates a cooling water circulation route when a heater line opens.

FIG. 6 illustrates a cooling water circulation route when a block line opens.

FIG. 7 illustrates a cooling water circulation route when a transmission line opens.

FIG. 8 illustrates a cooling water circulation route when a radiator line opens.

FIG. 9 illustrates how the cooling water temperature decreases when the transmission line opens.

FIGS. 10A and 10B illustrate a cooling system according to a first embodiment of the present invention: FIG. 10A depicts the relationships between the rotor angle of the flow channel switching valve and the opening ratios of inlet ports; and FIG. 10B depicts changes in the cooling water flow rates through the cooling water channels.

FIG. 11 is a graph from an experiment for confirming the effects of the first embodiment.

FIG. 12 is a flowchart illustrating how to set base values for the rotor angle of the flow channel switching valve and for the rotation speed or flow rate of an electric water pump in a cooling system according to a second embodiment of the present invention.

FIG. 13 is a flowchart illustrating how to calculate the rotation speed or flow rate of the electric water pump in the second embodiment.

FIG. 14 is a template providing the correspondence between the rotor angle of the flow channel switching valve and a correction variable for the discharge rate of the electric water pump in the second embodiment.

FIG. 15 is a flowchart illustrating how to correct the flow rate through the heater line based on temperature information from temperature sensors installed at different locations in a vehicle in a cooling system according to a third embodiment of the present invention.

FIGS. 16A to 16D are templates each providing the correspondence between the output from one of the temperature sensors and a correction variable for the rotor angle.

FIGS. 17A and 17B are templates each providing the correspondence between another environmental information and a correction variable for the rotor angle: FIG. 17A provides the correspondence between the opening degree of an air-mix door and the correction variable; and FIG. 17B provides the correspondence between the air volume of a blower fan and the correction variable.

### MODE FOR CARRYING OUT THE INVENTION

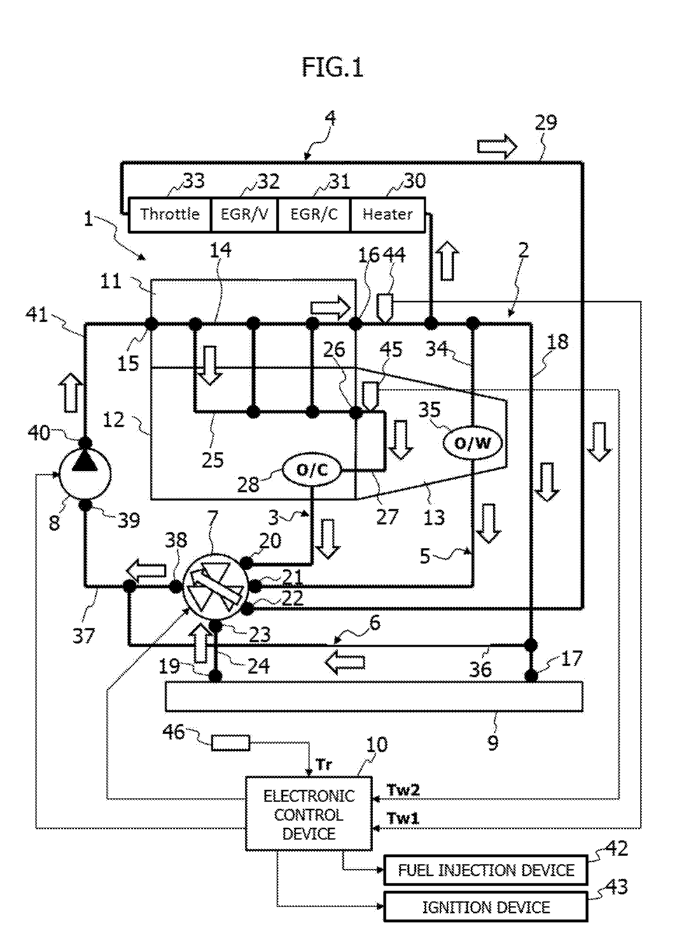

Hereinafter, an embodiment of the present invention will be described in detail with reference to the accompanying drawings. FIG. 1 is a schematic configuration diagram illustrating a cooling system according to an embodiment of the present invention. The cooling system for cooling an internal combustion engine 1 includes first to fourth cooling water channels 2 to 5, a flow channel switching valve 7, a water pump (ELWP) 8, a radiator 9, and an electronic control device 10.

Internal combustion engine 1, which is mounted on a vehicle, includes a cylinder head 11 and a cylinder block 12. A transmission 13 such as a continuously variable transmission (CVT), an example of a powertrain, is coupled to the output shaft of internal combustion engine 1. The output of transmission 13 is transmitted to drive wheels (not illustrated in the drawings), thereby causing the vehicle to travel.

Internal combustion engine 1 is provided with a head cooling water passage 14 which extends across the interior of cylinder head 11. Head cooling water passage 14 for cooling cylinder head 11, includes a cooling water inlet 15 and a cooling water outlet 16. Cooling water inlet 15 opens at one end of cylinder head 11 in the cylinder arrangement direction. Cooling water outlet 16 opens at the other end of cylinder head 11 in the cylinder arrangement direction. The cooling water supplied to cooling water inlet 15 of cylinder head 11 flows through head cooling water passage 14 while cooling cylinder head 11, and is then discharged from cooling water outlet 16 that opens at the other end of cylinder head 11.

To cooling water outlet 16 of cylinder head 11, one end of a first cooling water pipe 18 is connected. The other end of first cooling water pipe 18 is connected to a cooling water inlet 17 of radiator 9. To a cooling water outlet 19 of radiator 9, one end of a second cooling water pipe 24 is connected. The other end of second cooling water pipe 24 is connected to a fourth inlet port 23, among first to fourth inlet ports 20 to 23, of flow channel switching valve 7. In this way, a first cooling water channel (referred to as “radiator line” below) 2, including head cooling water passage 14, first cooling water pipe 18, and second cooling water pipe 24, is configured. Through radiator line 2, cooling water flows by way of cylinder head 11 and radiator 9.

Internal combustion engine 1 is further provided with a block cooling water passage 25. Block cooling water passage 25 for cooling cylinder block 12 branches off from head cooling water passage 14 and enters cylinder block 12, extending across the interior of cylinder block 12 and connecting to a cooling water outlet 26, which opens at the other end of cylinder block 12 in the cylinder arrangement direction.

Accordingly, some of the cooling water flowing through head cooling water passage 14 enters block cooling water passage 25 that branches off from head cooling water passage 14. Then, the cooling water flows through block cooling water passage 25 while cooling cylinder block 12, and is then discharged from cooling water outlet 26 that opens at the other end of cylinder block 12.

To cooling water outlet 26 of cylinder block 12, one end of a third cooling water pipe 27 is connected. Third cooling water pipe 27 is provided for allowing an oil cooler (O/C) 28 disposed on third cooling water pipe 27 to exchange heat between the cooling water flowing through third cooling water pipe 27 and lubricating oil for internal combustion engine 1 so as to cool the lubricating oil for internal combustion engine 1. The other end of third cooling water pipe 27 is connected to first inlet port 20 of flow channel switching valve 7. In this way, a second cooling water channel (referred to as “block line” below) 3, including block cooling water passage 25 and third cooling water pipe 27, is configured. Through block line 3, cooling water flows by way of cylinder block 12 and bypasses radiator 9.

One end of a fourth cooling water pipe 29 is connected to an intermediate point of first cooling water pipe 18. The cooling water flowing through head cooling water passage 14 is heated by heat exchange with cylinder head 11. Fourth cooling water pipe 29 is provided in order to use such heated cooling water for vehicle air heating. On fourth cooling water pipe 29, a heater core for vehicle air heating (heat exchanger for air heating) 30, a water-cooled exhaust gas recirculation (EGR) cooler 31, an EGR control valve 32, and a throttle valve 33 are disposed in this order from upstream to downstream in the cooling water flow direction. EGR cooler 31 and EGR control valve 32 constitute an exhaust gas recirculation device. Throttle valve 33 regulates the amount of air intake in internal combustion engine 1. The other end of fourth cooling water pipe 29 is connected to third inlet port 22 of flow channel switching valve 7. In this way, a third cooling water channel (referred to as “heater line” below) 4, including head cooling water passage 14 and fourth cooling water pipe 29, is configured. Through heater line 4, cooling water flows by way of cylinder head 11 and heater core 30, and bypasses radiator 9.

Heater core 30 achieves an air heating function by exchanging heat between the cooling water flowing through fourth cooling water pipe 29 and air for air conditioning so as to heat the air for air conditioning. EGR cooler 31 exchanges heat between the cooling water flowing through fourth cooling water pipe 29 and an exhaust recirculated into an intake system of internal combustion engine 1 by the exhaust gas recirculation device, thus lowering the temperature of the exhaust so as to curb generation of nitrogen oxides during combustion. EGR control valve 32 and throttle valve 33 are heated by exchanging heat with the cooling water flowing through fourth cooling water pipe 29, thus preventing the freezing of moisture in the exhaust or in the intake air. Accordingly, heater line 4 allows the cooling water having passed through cylinder head 11 to be partially diverted from first cooling water pipe 18 to fourth cooling water pipe 29, thus introducing some of the cooling water having passed through cylinder head 11 into heater core 30, EGR cooler 31, EGR control valve 32, and throttle valve 33 so as to allow this cooling water to exchange heat therewith.

One end of a fifth cooling water pipe 34 is connected to an intermediate point of first cooling water pipe 18. Fifth cooling water pipe 34 is provided for allowing an oil warmer (O/W) 35 disposed on fifth cooling water pipe 34 to exchange heat between the cooling water flowing through fifth cooling water pipe 34 and hydraulic oil of transmission 13 so as to heat the hydraulic oil of transmission 13. The other end of fifth cooling water pipe 34 is connected to second inlet port 21 of flow channel switching valve 7. Accordingly, fifth cooling water pipe 34 allows the cooling water having passed through cylinder head 11 to be partially diverted from first cooling water pipe 18, thus introducing some of the cooling water having passed through cylinder head 11 into oil warmer 35 so as to heat the hydraulic oil through heat exchange between this cooling water and the hydraulic oil. In this way, a fourth cooling water channel (referred to as “CVT O/W line” below) 5, including head cooling water passage 14 and fifth cooling water pipe 34, is configured as a transmission line. Through CVT O/W line 5, cooling water flows by way of cylinder head 11 and oil warmer 35 of transmission 13, and bypasses radiator 9.

A sixth cooling water pipe 36 is connected at one end to an intermediate point of first cooling water pipe 18, and at the other end to an intermediate point of a seventh cooling water pipe 37, which will be described later. Specifically, in first cooling water pipe 18, the connection point to sixth cooling water pipe 36 is located downstream to the connection point to fourth cooling water pipe 29 and downstream to the connection point to fifth cooling water pipe 34. One end of seventh cooling water pipe 37 is connected to an outlet port 38 of flow channel switching valve 7. In this way, a fifth cooling water channel (referred to as “bypass line” below) 6, including sixth cooling water pipe 36, is configured. Through bypass line 6, the cooling water that has been partially diverted from first cooling water pipe 18 enters seventh cooling water pipe 37 at a point near the outlet of flow channel switching valve 7 after bypassing radiator 9.

In this way, a cooling water circuit, including radiator line 2, block line 3, heater line 4, CVT O/W line 5, seventh cooling water pipe 37, and an eighth cooling water pipe 41, is configured. Seventh cooling water pipe 37 connects outlet port 38 of flow channel switching valve 7 with an intake port 39 of a water pump 8, which will be described later. Eighth cooling water pipe 41 connects a discharge port 40 of water pump 8 with cooling water inlet 15 of cylinder head 11.

Flow channel switching valve 7 is provided at cooling water outlets of radiator line 2, block line 3, heater line 4, and CVT O/W line 5. Flow channel switching valve 7 switches between the plurality of cooling water channels so as to sequentially open at least one of the cooling water channels in accordance with a warm-up state of internal combustion engine 1. The opening and closing of flow channel switching valve 7 is controlled by electronic control device 10, which will be described later, so as to adjust the cooling water distribution rates of the cooling water channels.

To be more specific, flow channel switching valve 7 is, for example, a rotary flow channel switching valve that includes a stator having first to fourth inlet ports 20 to 23 and outlet port 38, and a rotor having flow channels therein and rotatably fitted in the stator. Flow channel switching valve 7 opens one or more of the ports of the stator in an appropriate manner in accordance with the angle of the rotor changed from a reference angle by an electric actuator such as an electric motor. This configuration allows adjusting the cooling water distribution rates of the cooling water channels by changing the opening area ratios of first to fourth inlet ports 20 to 23 in accordance with the angle of the rotor.

Water pump 8 is disposed on the cooling water channel connecting flow channel switching valve 7 and cylinder head 11. Water pump 8 is an electric pump driven by an electric motor and controlled by electronic control device 10, which will be described below. Water pump 8 circulates cooling water through the cooling water channels by drawing cooling water from intake port 39 and discharging the cooling water from discharge port 40 toward cylinder head 11.

Electronic control device 10 is electrically connected to flow channel switching valve 7 and water pump 8. When CVT O/W line 5 opens, electronic control device 10 controls the opening and closing of flow channel switching valve 7 so as to restrict the cooling water distribution rate of heater line 4 while maintaining the flow rate of cooling water through CVT O/W line 5 unchanged. At the same time, electronic control device 10 also controls water pump 8 to restrict the discharge flow rate of water pump 8. In order to maintain the flow rate of cooling water through block line 3 constant, electronic control device 10 may restrict the discharge flow rate of water pump 8 and adjust the opening degree of flow channel switching valve 7 to heater line 4 and CVT O/W line 5. This makes it possible to accelerate temperature increase of cooling water even when the temperature increase of cooling water temporarily slows down. Note that the term “constant” used herein may include a state with acceptable changes.

Electronic control device 10 may control the opening and closing of flow channel switching valve 7 so as to change the flow rate of cooling water through heater line 4 based on various control parameters for an air conditioning system, including temperature information from temperature sensors installed at different locations in the vehicle. Examples of such control parameters include temperature information from sensors such as an exterior air sensor, an interior air sensor, an evaporator intake temperature sensor, and a solar radiation sensor, and information such as the air volume of a blower fan, the opening degree of an air-mix door, and the air volume of vehicle-speed air.

In addition, electronic control device 10 also has a function of controlling a fuel injection device 42 and an ignition device 43 of internal combustion engine 1, and an idle stop (idle reduction) function for temporarily stopping internal combustion engine 1 while, for example, the vehicle waits for a traffic light. However, electronic control device 10 does not have to perform various controls on internal combustion engine 1. In this case, a separate electronic control device may be provided for controlling components, such as fuel injection device 42 and ignition device 43, of internal combustion engine 1, and electronic control device 10 may communicate with this separate electronic control device.

In FIG. 1, reference numeral 44 indicates a temperature sensor for measuring an engine water temperature. Reference numeral 45 indicates a temperature sensor for measuring the temperature of cooling water discharged from cylinder block 12. Reference numeral 46 indicates a temperature sensor for measuring the temperature in the vehicle interior (vehicle interior temperature).

Next, an operation of the cooling system having the above configuration will be described.

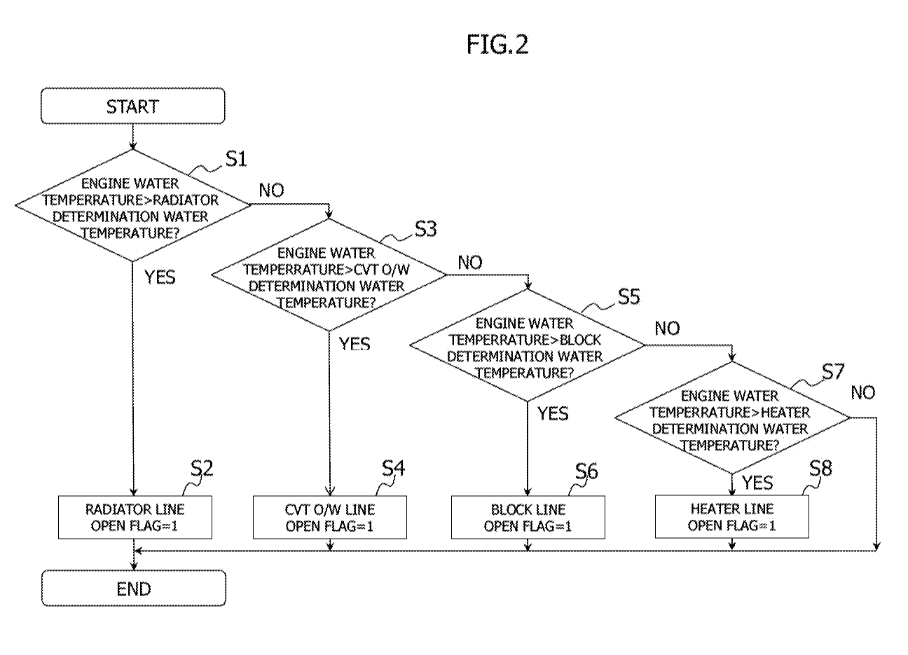

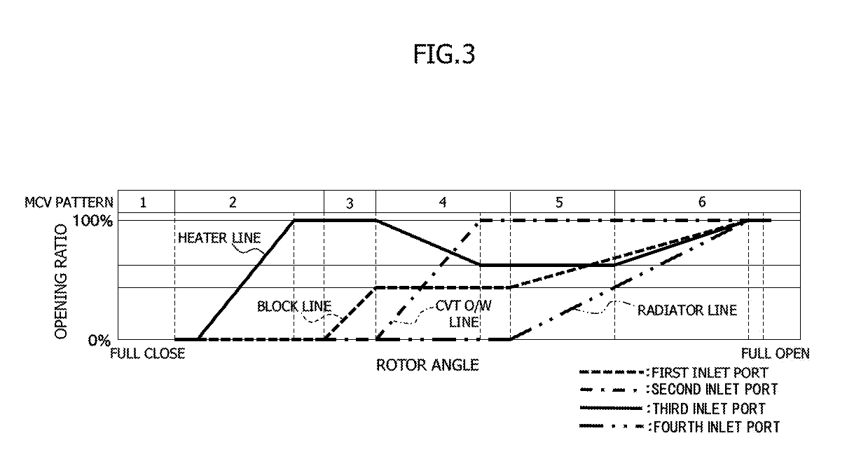

FIG. 2 is a flowchart illustrating how to determine operation conditions of the cooling system for internal combustion engine 1. FIG. 3 illustrates the operation of flow channel switching valve 7 of the cooling system. Specifically, FIG. 3 depicts the relationships between the rotor angle of flow channel switching valve 7 and the opening ratios of first to fourth inlet ports 20 to 23.

When the engine starts, temperature sensor 44 disposed near cooling water outlet 16 of cylinder head 11 senses the engine water temperature. The information indicating the temperature sensed by temperature sensor 44 is transmitted to electronic control device 10. In response, electronic control device 10 sequentially compares this temperature information with a radiator determination water temperature, a CVT O/W determination water temperature, a block determination water temperature, and a heater determination water temperature. The radiator determination water temperature is a threshold for determining whether to open radiator line 2. The CVT O/W determination water temperature is a threshold for determining whether to open CVT O/W line 5. The block determination water temperature is a threshold for determining whether to open block line 3. The heater determination water temperature is a threshold for determining whether to open heater line 4. These determination water temperatures are related in the following way:

radiator determination water temperature >CVT O/W determination water temperature >block determination water temperature >heater determination water temperature.

First, in step S1, the engine water temperature is compared with the radiator determination water temperature. At engine start, the determination result in step S1 is “NO” since the cooling water is not heated yet. Thus, radiator line 2 stays closed, and the operation proceeds to step S3.

In step S3, the engine water temperature is compared with the CVT O/W determination water temperature. Since the cooling water is not sufficiently heated yet at that time, the determination result in step S3 is “NO”. Thus, CVT O/W line 5 stays closed, and the operation proceeds to step S5.

In step S5, the engine water temperature is compared with the block determination water temperature. Since the engine water temperature is not sufficiently increased yet and still stays below the block determination water temperature at that time, the determination result in step S5 is “NO”. Thus, block line 3 stays closed, and the operation proceeds to step S7.

In step S7, the engine water temperature is compared with the heater determination water temperature. Since the engine water temperature still stays below the heater determination water temperature immediately after engine start, the determination result in step S7 is “NO”. Thus, heater line 4 stays closed, and the sequence of steps for determining the operation conditions ends.

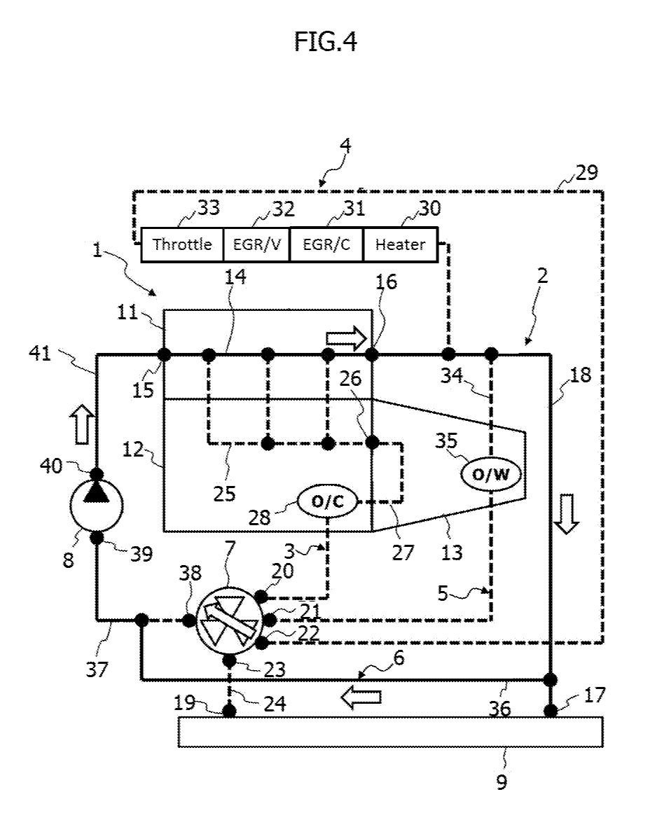

Immediately after engine start, that is, when the rotor angle is within a predetermined angle range from the reference angle at which the rotor is regulated by a stopper, flow channel switching valve 7 implements a first pattern. In the first pattern, all first to fourth inlet ports 20 to 23 are closed as illustrated in FIG. 3. In this first pattern, heater line 4, block line 3, and radiator line 2 are closed, so that cooling water discharged from water pump 8 flows through head cooling water passage 14 and first cooling water pipe 18 and bypass line 6, as illustrated in FIG. 4 so as to cool only cylinder head 11 of internal combustion engine 1. Note that the conditions in which all first to fourth inlet ports 20 to 23 are closed include not only the condition in which the opening area of each of first to fourth inlet ports 20 to 23 is zero, but also the conditions in which the opening area of each of first to fourth inlet ports 20 to 23 is the minimum value greater than zero, that is, the conditions in which cooling water slightly leaks from first to fourth inlet ports 20 to 23.

After a lapse of a predetermined time, the steps for determining the operation conditions of FIG. 2 are performed again. While cooling water cools only cylinder head 11 immediately after engine start, cooling water is heated by heat exchange with cylinder head 11. When, as a result, the engine water temperature increases to exceed the heater determination water temperature, the determination result in step S7 becomes “YES”. Then, the operation proceeds to step S8, in which a flag indicating that the conditions to open heater line 4 have been satisfied is raised. Thereby, electronic control device 10 causes flow channel switching valve 7 to rotate the rotor.

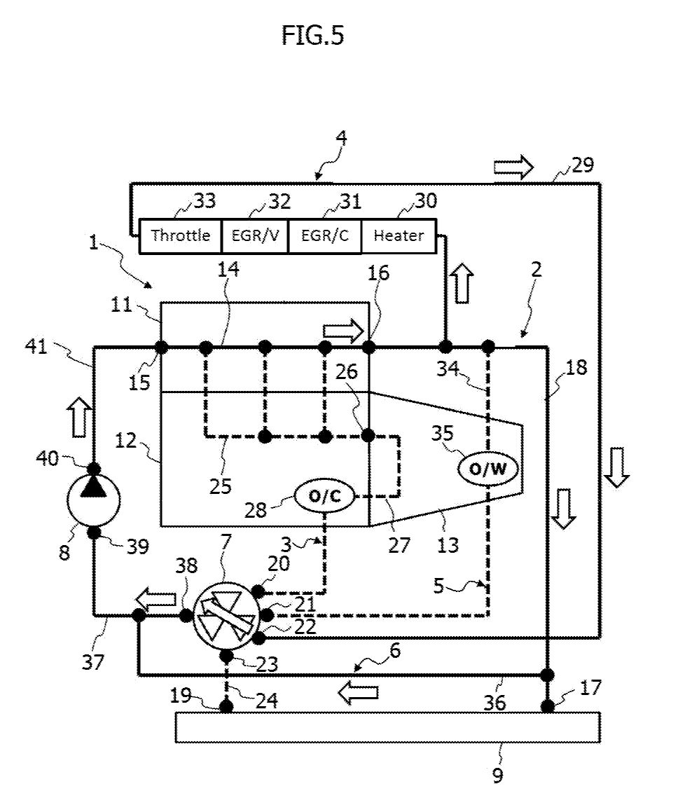

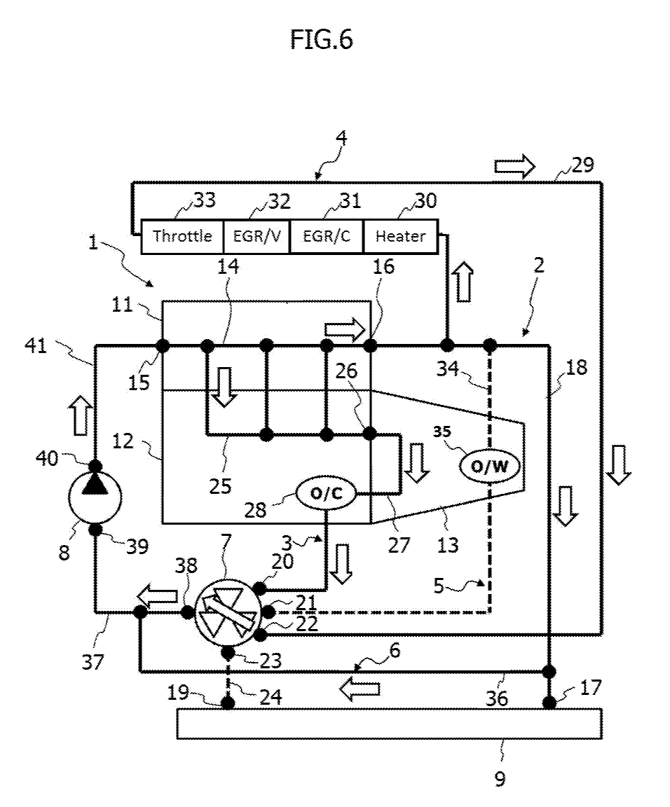

Controlled by electronic control device 10, flow channel switching valve 7 rotates the rotor to implement a second pattern illustrated in FIG. 3. The second pattern is implemented after the rotor angle increases beyond the angle range within which all first to fourth inlet ports 20 to 23 are closed. In the second pattern, third inlet port 22 gradually opens to a predetermined opening ratio (to the opening ratio of 100% (full open), for example), and is then maintained at this constant opening ratio even as the rotor angle increases. In this second pattern, heater line 4 opens, so that cooling water discharged from water pump 8 flows through head cooling water passage 14, first cooling water pipe 18, and bypass line 6, and through heater line 4, as illustrated in FIG. 5. As a result, the cooling water cools cylinder head 11 of internal combustion engine 1 and heater core 30 and the like.

While circulating through head cooling water passage 14, first cooling water pipe 18, and bypass line 6, and through heater line 4, cooling water is heated by heat exchange with cylinder head 11. When, as a result, the engine water temperature further increases to exceed the block determination water temperature, the determination result in step S5 becomes “YES”. Then, the operation proceeds to step S6, in which a flag indicating that the conditions to open block line 3 have been satisfied is raised. Thereby, electronic control device 10 causes flow channel switching valve 7 to further rotate the rotor.

Controlled by electronic control device 10, flow channel switching valve 7 further rotates the rotor to implement a third pattern illustrated in FIG. 3. The third pattern is implemented after the rotor angle exceeds the angle at which the opening ratio of third inlet port 22 reaches the constant predetermined ratio. In the third pattern, first inlet port 20 starts to open, and then gradually opens to a predetermined opening ratio along with an increase in the rotor angle. Meanwhile, the opening ratio of third inlet port 22 is maintained unchanged. In this third pattern, block line 3 opens, so that cooling water discharged from water pump 8 flows through block line 3 in addition to through head cooling water passage 14, first cooling water pipe 18, and bypass line 6, and through heater line 4. As a result, the cooling water cools cylinder head 11 and cylinder block 12 of internal combustion engine 1, and heater core 30 and the like.

While circulating through block line 3 as well as through head cooling water passage 14, first cooling water pipe 18, and bypass line 6, and through heater line 4, cooling water is heated by heat exchange with cylinder head 11. When, as a result, the engine water temperature further increases to exceed the CVT O/W determination water temperature, the determination result in step S3 becomes “YES”. Then, the operation proceeds to step S4, in which a flag indicating that the conditions to open CVT O/W line 5 have been satisfied is raised. Thereby, electronic control device 10 causes flow channel switching valve 7 to further rotate the rotor.

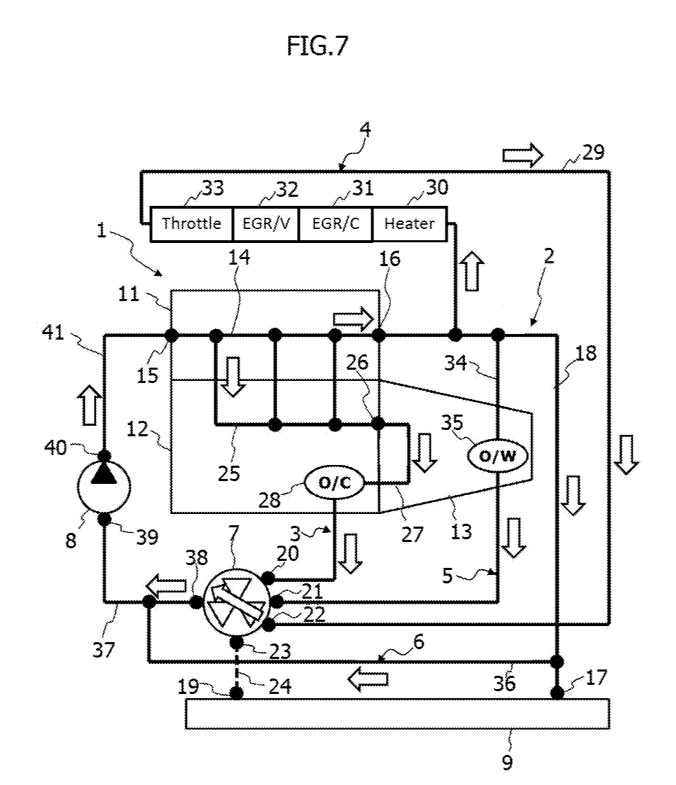

Controlled by electronic control device 10, flow channel switching valve 7 further rotates the rotor to implement a fourth pattern illustrated in FIG. 3. The fourth pattern is implemented when the rotor angle exceeds the angle at which the opening ratio of first inlet port 20 reaches the predetermined opening ratio. In the fourth pattern, second inlet port 21 gradually opens until its opening ratio reaches a predetermined ratio (the opening ratio of 100% (full open), for example), and is then maintained at the predetermined opening ratio even as the rotor angle increases. Meanwhile, the opening ratio of third inlet port 22 is gradually reduced from, for example, the opening ratio of 100% to a predetermined ratio, and then maintained at this predetermined ratio. First inlet port 20 remains maintained at the predetermined opening ratio, so that the cooling water rate through block line 3 is maintained constant. In this fourth pattern, CVT O/W line 5 opens, so that cooling water discharged from water pump 8 flows through CVT O/W line 5 in addition to through head cooling water passage 14, first cooling water pipe 18, and bypass line 6, through heater line 4, and through block line 3, as illustrated in FIG. 7. As a result, the cooling water cools cylinder head 11 and cylinder block 12 of internal combustion engine 1, and heater core 30 and the like, as well as heats the lubricating oil for transmission 13.

While circulating through CVT O/W line 5 as well as through head cooling water passage 14, first cooling water pipe 18, and bypass line 6, through heater line 4, and through block line 3, cooling water is heated by heat exchange with cylinder head 11. When, as a result, the engine water temperature further increases to exceed the radiator determination water temperature, the determination result in step S1 becomes “YES”. Then, the operation proceeds to step S2, in which a flag indicating that the conditions to open radiator line 2 have been satisfied is raised. Thereby, electronic control device 10 causes flow channel switching valve 7 to further rotate the rotor.

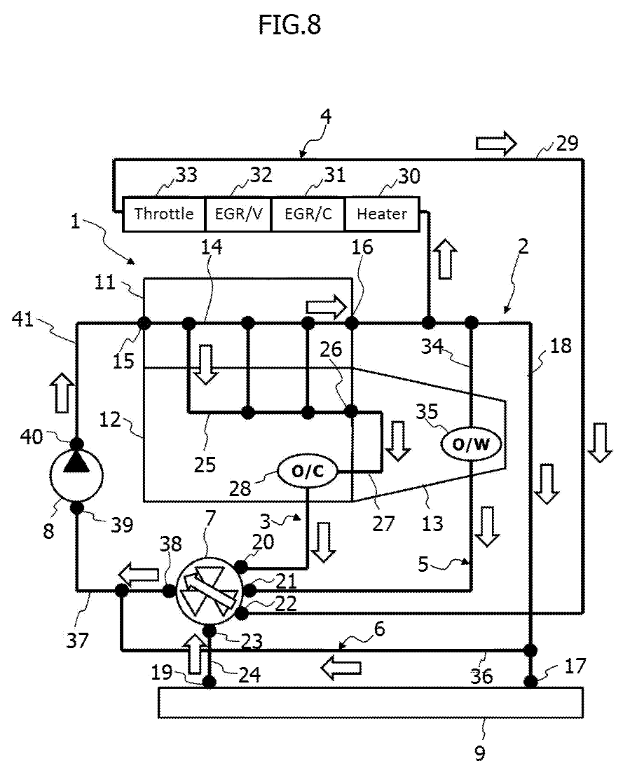

Controlled by electronic control device 10, flow channel switching valve 7 further rotates the rotor to implement a fifth pattern illustrated in FIG. 3. The fifth pattern is implemented after the rotor angle exceeds the angle at which the opening ratio of second inlet port 21 reaches the predetermined constant opening ratio. In the fifth pattern, fourth inlet port 23 starts to open, and then the opening ratio of fourth inlet port 23 gradually increases along with an increase in the rotor angle. Third inlet port 22 is maintained unchanged at the predetermined opening ratio. Meanwhile, first inlet port 20 starts to gradually increase its opening ratio, and second inlet port 21 is maintained at the full open state. In this fifth pattern, radiator line 2 opens. Cooling water discharged from water pump 8 flows through CVT O/W line 5 as well as through head cooling water passage 14, first cooling water pipe 18, and bypass line 6, through heater line 4, and through block line 3, as illustrated in FIG. 8. Thus, the cooling water cools cylinder head 11 and cylinder block 12 of internal combustion engine 1, and heater core 30 and the like, as well as heats the lubricating oil for transmission 13. In addition, since the cooling water also flows through radiator 9, the cooling water temperature can be maintained at an allowable temperature or less.

When the rotor of flow channel switching valve 7 rotates further, flow channel switching valve 7 implements a sixth pattern. In the sixth pattern, the opening ratios of the first, third, and fourth inlet ports 20, 22, 23 gradually increase to 100%.

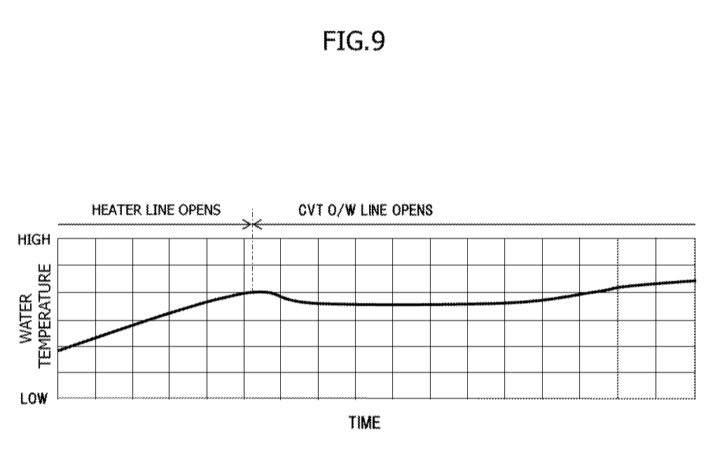

In the operation of flow channel switching valve 7 as illustrated in FIG. 3, when the fourth pattern is implemented and CVT O/W line 5 opens, the low-temperature cooling water in CVT O/W line 5 starts to circulate. As a result, the increase of the engine water temperature temporarily slows down as illustrated in FIG. 9. In addition, when CVT O/W line 5 opens, heat is conducted away from the cooling water flowing through CVT O/W line 5 to the lubricating oil for transmission 13 so as to heat the lubricating oil. This further prolongs the slowdown in increase of the engine water temperature, and thus increases the time required for the engine water to start to increase in temperature again. This problem is like that of conventional techniques.

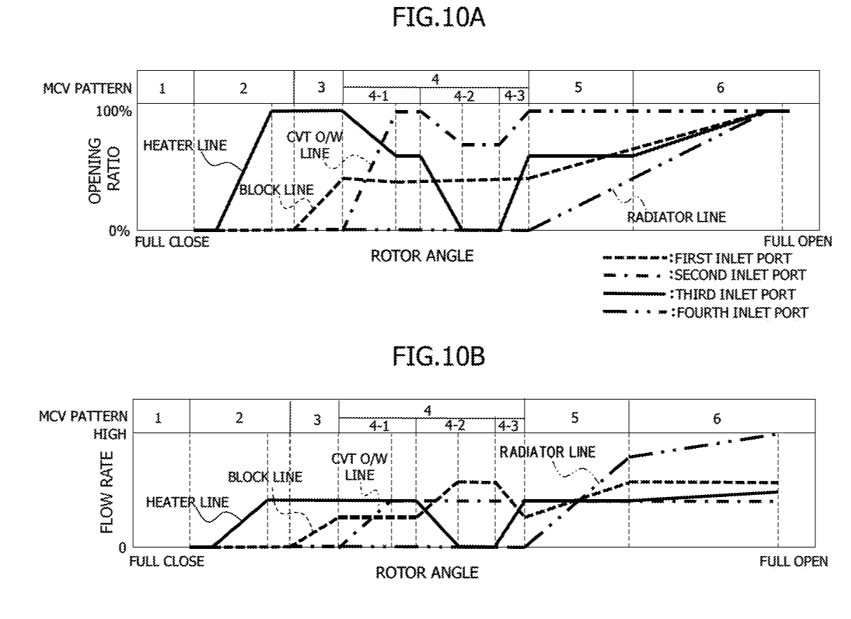

The cooling system according to the present invention is to shorten such temporary slowdown in increase of the cooling water temperature so as to accelerate the increase in the engine water temperature. An operation of the cooling system according to the present invention (first embodiment) will be described with reference to FIGS. 10A and 10B below. The following description is focused on a technical feature of the present invention, i.e. the flow channel switching operation in the fourth pattern among the flow channel switching patterns of flow channel switching valve 7.

### First Embodiment

As illustrated in FIG. 10A, immediately before the start of the fourth pattern, first inlet port 20 of flow channel switching valve 7 is opened at a predetermined opening ratio, third inlet port 22 is fully opened, and second and fourth inlet ports 21, 23 are closed.

Then, the rotor of flow channel switching valve 7 rotates and implements the fourth pattern. First, a first phase (4-1) of the fourth pattern is implemented as illustrated in FIG. 10A. In the first phase (4-1), second inlet port 21 gradually opens until, for example, it is fully opened. Then, second inlet port 21 is maintained in the full open state even as the rotor angle increases. Meanwhile, third inlet port 22 gradually closes from the full open state to a predetermined constant opening ratio, and then maintained at this predetermined constant opening ratio. First inlet port 20 is maintained at the constant opening ratio, so that the cooling water rate through block line 3 is maintained constant as illustrated in FIG. 10B. When second inlet port 21 opens and thus CVT O/W line 5 opens, the increase in the engine water temperature temporarily slows down as described above.

In a second phase (4-2) of the fourth pattern in FIG. 10A, the rotor of flow channel switching valve 7 is further rotated, and third inlet port 22 gradually closes to an opening ratio (the opening ratio of 0% (full close), for example), which is still less than the above constant opening ratio, and then maintained at this opening ratio. This reduces the flow rate through heater line 4 as illustrated in FIG. 10B, thus limiting water temperature decrease due to heat removal by heater core 30. The water temperature around 50° C. is sufficient for air heating. When the cooling water temperature in heater line 4 is sufficiently high for air heating, third inlet port 22 may be closed as illustrated in FIG. 10A so as to temporarily stop the cooling water from flowing through heater line 4 as illustrated in FIG. 10B. At the same time, second inlet port 21 gradually closes to a constant opening ratio, and is then maintained at this opening ratio. Thereby, the flow rate through CVT O/W line 5 is maintained constant as illustrated in FIG. 10B, thus maintaining the speed of temperature increase in the lubricating oil for transmission 13. Meanwhile, first inlet port 20 remains maintained unchanged. Thus, the flow rate through block line 3 increases by an amount corresponding to a reduction in the flow rate through heater line 4 as illustrated in FIG. 10B. As a result, the cooling water increases in temperature, since an increased rate of cooling water is heated by heat exchange with cylinder block 12 while flowing through block line 3. This shortens the slowdown in increase of the cooling water temperature, thus accelerating the water temperature increase.

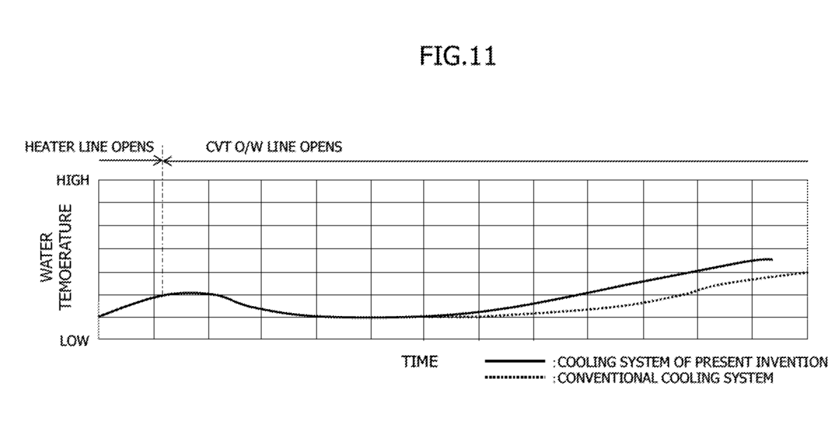

FIG. 11 is a graph from an experiment for confirming the effects of the cooling system according to the present invention. In FIG. 11, solid line indicates the speed of water temperature recovery in the cooling system according to the present invention, and dashed line indicates the speed of water temperature recovery in a conventional cooling system (corresponding to the operation of flow channel switching valve 7 illustrated in FIG. 3). As is clear from FIG. 11, the water temperature recovery time is reduced in the cooling system according to the present invention as compared to in the conventional cooling system.

In a third phase (4-3) of the fourth pattern in FIG. 10A, after the water temperature is sufficiently recovered, the rotor of flow channel switching valve 7 is further rotated, and third inlet port 22 gradually opens back to the above constant opening ratio. This opens heater line 4 again as illustrated in FIG. 10B, and the cooling water resumes to flow through heater line 4 at the constant flow rate. At the same time, the opening ratio of second inlet port 21 gradually increases until it is fully opened so as to maintain the flow rate of cooling water through CVT O/W line 5 constant. Meanwhile, first inlet port 20 remains maintained unchanged. Thus, the flow rate of cooling water through block line 3 decreases by an amount corresponding to an increase in the flow rate through heater line 4, and returns to the previous rate.

After that, the rotation angle of the rotor of flow channel switching valve 7 and the opening ratios of first to fourth inlet ports 23 change in a similar manner to the fifth and sixth patterns illustrated in FIG. 3.

The plurality of flow channels provided in the rotor of flow channel switching valve 7 are formed to have shapes, widths, and depths which are defined so as to ensure the relationship between the rotor angle and the opening ratios of first to fourth inlet ports 20 to 23 as illustrated in FIG. 10A.

In the above first embodiment, the cooling water discharge rate of water pump 8 is set constant. In this case, the flow rate through block line 3 increases by an amount corresponding to a reduction in the flow rate through heater line 4 as described above. In order to maintain the flow rate of cooling water through block line 3 constant in the second phase (4-2) of the fourth pattern, the cooling water discharge rate of water pump 8 may be reduced along with gradual reduction in the opening ratios of second and third inlet ports 21, 22 of flow channel switching valve 7. This allows a constant rate of cooling water to flow through block line 3, thus further accelerating temperature increase of cooling water flowing through block line 3. Thus, even in this case, temperature increase of cooling water can be accelerated after the temporary slowdown.

Reducing the cooling water discharge rate of water pump 8 also reduces the flow rate through CVT O/W line 5. This delays the heating of the lubricating oil for transmission 13, which is problematic. To avoid this, it is necessary to maintain the flow rate through block line 3 and the flow rate through CVT O/W line 5 constant by controlling the rotor angle of flow channel switching valve 7 to adjust the opening ratios of second and third inlet ports 21, 22 while adjusting (correcting) the cooling water discharge rate of water pump 8.

Below, another operation of the cooling system according to the present invention (second embodiment) will be described.

### Second Embodiment

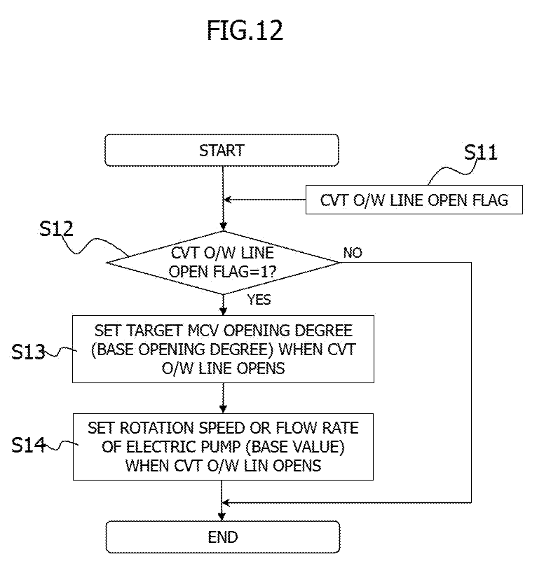

First, the base values for the rotor angle (MCV opening degree) of flow channel switching valve 7 and for the rotation speed or flow rate of electric water pump 8 when CVT O/W line 5 opens are set. FIG. 12 is a flowchart illustrating how to set the base values for the rotor angle (MCV opening degree) and for the rotation speed or flow rate of electric water pump 8.

In step S3 in the processing for determining the operation conditions of FIG. 2, it is determined whether the engine water temperature exceeds the CVT O/W determination water temperature. The determination result is received in step S11, and the operation proceeds to step S12. In step S12, based on the determination result in step S3, it is determined whether the conditions to open CVT O/W line 5 have been satisfied. When it is determined that these conditions have not yet been satisfied (the determination result is “NO”), the processing for setting the base values for the rotor angle (MCV opening degree) of flow channel switching valve 7 and for the rotation speed or flow rate of electric water pump 8 ends.

When it is determined that the conditions to open CVT O/W line 5 have been satisfied, i.e. the determination result is “YES” in step S12, the operation proceeds to step S13. In step S13, the base value for the rotor angle (MCV opening degree) when CVT O/W line 5 opens is set. Specifically, the rotor angle (MCV opening degree) at the beginning of the second phase (4-2) of the fourth pattern in FIG. 10A is set as the base MCV opening degree. Then, the operation proceeds to step S14, in which the rotation speed or flow rate of electric water pump 8 at the start of opening CVT O/W line 5 is set as the base value.

In this way, the base MCV opening degree and the base value for the rotation speed or flow rate of electric water pump 8 are set. Then, the rotor angle of flow channel switching valve 7 is controlled such that the opening ratios of second and third inlet ports 21, 22 are adjusted, as well as the cooling water discharge rate of water pump 8 is adjusted (corrected), so as to maintain the flow rates through block line 3 and CVT O/W line 5 constant with reference to these base values.

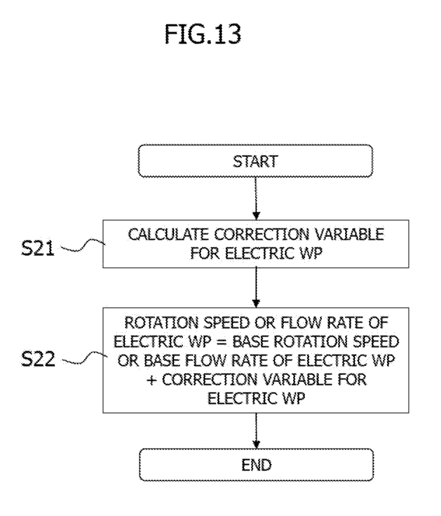

FIG. 13 is a flowchart illustrating how to correct the rotation speed or flow rate of electric water pump 8 when CVT O/W line 5 opens.

First, in step S21, a correction variable for the discharge rate of electric water pump 8 is calculated. Specifically, the correction variable for the discharge rate of electric water pump 8 is calculated with reference to a template for water pump discharge correction as illustrated in FIG. 14. The template for water pump discharge correction provides the correspondence between the rotor angle (MCV opening degree) of flow channel switching valve 7 and the correction variable for the cooling water discharge rate of electric water pump 8 when CVT O/W line 5 opens, particularly, in the first half of the second phase (4-2) of the fourth pattern. In FIG. 14, the abscissa represents the rotor angle (MCV opening degree), and the ordinate represents the correction variable for (amount of reduction from) the cooling water discharge rate of electric water pump 8.

To be more specific, in the absence of water pump discharge correction, the flow rate through block line 3 gradually increases as the rotor angle (MCV opening degree) increases and the opening ratios of second and third inlet ports 21, 22 gradually decrease in the first half of the second phase (4-2) of the fourth pattern in FIG. 10A. To avoid this, with reference to the template of FIG. 14, the correction variable for (amount of reduction from) the discharge rate of electric water pump 8 is calculated in accordance with the rotor angle (MCV opening degree) so as to maintain the flow rate through block line 3 constant even as the rotor angle (MCV opening degree) increases. Then, the operation proceeds to step S22, in which the rotation speed or flow rate of electric water pump 8 is calculated by adding the rotation speed or flow rate corresponding to the thus-calculated discharge correction variable (reduction variable) to the base value for the rotation speed or flow rate of electric water pump 8 set in step S14 of FIG. 12. As described above, the cooling water discharge rate of water pump 8 is reduced by an amount corresponding to the thus-calculated discharge correction variable from the cooling water discharge rate of water pump 8 at the start of the second phase (4-2) of the fourth pattern. This allows maintaining the flow rates through block line 3 and CVT O/W line 5 constant even if reducing the flow rate through heater line 4.

In the above second embodiment, the flow rate of cooling water through block line 3 is maintained unchanged by restricting the discharge flow rate of electric water pump 8 and adjusting the MCV opening degree of flow channel switching valve 7 to heater line 4 and CVT O/W line 5. However, the present invention is not limited to this. Alternatively, the discharge flow rate of electric water pump 8 may be restricted when the cooling water distribution rate of heater line 4 is restricted. Specifically, the discharge flow rate of electric water pump 8 is reduced so as to correct the increase of the cooling water flowing through CVT O/W line 5 caused by restricting the cooling water distribution rate of heater line 4. In this case, the flow rate through block line 3 may be reduced while the flow rate through CVT O/W line 5 is maintained.

The cooling system according to the present invention may change the flow rate through heater line 4 in the first half of the second phase (4-2) of the fourth pattern in accordance with various control parameters for the air conditioning system (third embodiment). The third embodiment will be described below.

### Third Embodiment

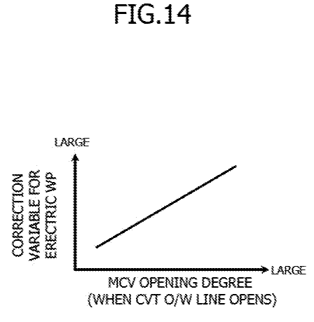

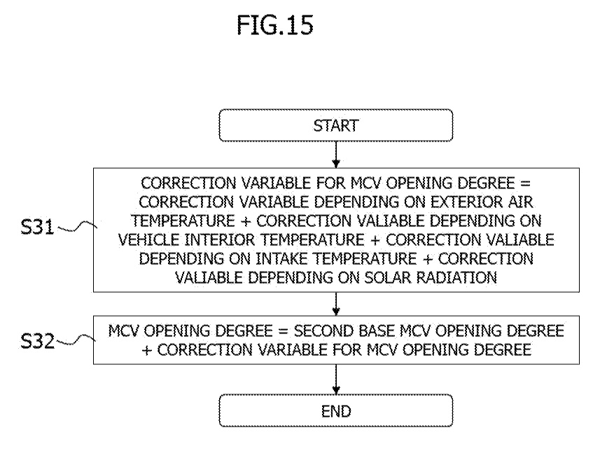

FIG. 15 is a flowchart illustrating how to correct the flow rate through heater line 4 based on temperature information from the temperature sensors installed at different locations in the vehicle.

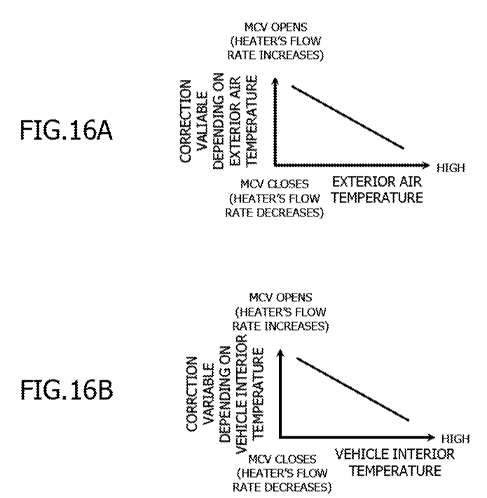

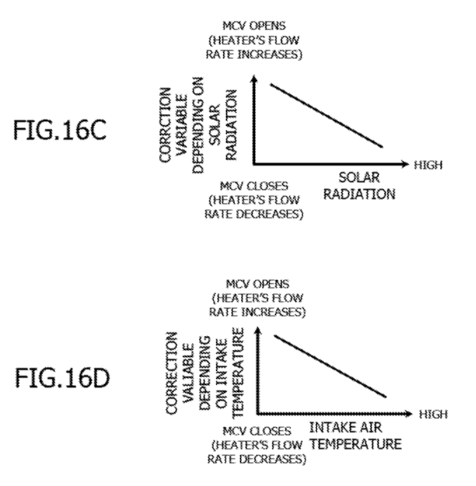

First, in step S31, the correction variable for the MCV opening degree is calculated. Specifically, a correction variable for the MCV opening degree depending on the exterior air temperature is calculated first by comparing the temperature information from the exterior air sensor with a template as illustrated in FIG. 16A. The template, which is for correcting the flow rate through heater line 4 depending on the exterior air temperature, is stored in electronic control device 10.

To be more specific, during the first half of the second phase (4-2) of the fourth pattern, the amount of increase or decrease in exterior air temperature at each current moment from baseline is calculated first. The baseline is set to the exterior air temperature sensed at the rotor angle of flow channel switching valve 7 at which second inlet port 21 reaches the constant opening ratio after having gradually closed as the rotor of flow channel switching valve 7 rotates (this rotor angle will be referred to as “second base MCV opening degree” below). Then, the calculated amount of increase or decrease in exterior air temperature is compared with the template for correction as illustrated in FIG. 16A, and thereby the correction variable, i.e. the amount of change to the rotor angle of flow channel switching valve 7, depending on the exterior air temperature is calculated. The calculated correction variable is temporarily stored in a storage unit of electronic control device 10.

FIG. 16B illustrates a correction variable for the flow rate through heater line 4 depending on the vehicle interior temperature. The correction variable, i.e. the amount of change to the MCV opening degree of flow channel switching valve 7, is calculated by comparing the temperature information from the interior air sensor with a template for correction. The template, which is for correction depending on the vehicle interior temperature, is stored in electronic control device 10. To be more specific, during the first half of the second phase (4-2) of the fourth pattern, the amount of increase or decrease in interior air temperature at each current moment from baseline is calculated first. The baseline is set to the interior air temperature sensed when the rotor angle of flow channel switching valve 7 is equal to the second base MCV opening degree. Then, the calculated amount of increase or decrease in interior air temperature is compared with the template for correction as illustrated in FIG. 16B, and thereby the correction variable, i.e. the amount of change to the rotor angle of flow channel switching valve 7, depending on the interior air temperature is calculated. The calculated correction variable is temporarily stored in the storage unit of electronic control device 10.

FIG. 16C illustrates a correction variable for the flow rate through heater line 4 depending on the amount of solar radiation. The correction variable, i.e. the amount of change to the MCV opening degree of flow channel switching valve 7, is calculated by comparing the temperature information from the solar radiation sensor with a template for correction. The template, which is for correction depending on the amount of solar radiation, is stored in electronic control device 10. To be more specific, during the first half of the second phase (4-2) of the fourth pattern, the amount of increase or decrease in solar radiation at each current moment from baseline is calculated first. The baseline is set to the amount of solar radiation sensed when the rotor angle of flow channel switching valve 7 is equal to the second base MCV opening degree. Then, the calculated amount of increase or decrease in solar radiation is compared with the template for correction as illustrated in FIG. 16C, and thereby the correction variable, i.e. the amount of change to the rotor angle of flow channel switching valve 7, depending on the amount of solar radiation is calculated. The calculated correction variable is also temporarily stored in the storage unit of electronic control device 10.

FIG. 16D illustrates a correction variable for the flow rate through heater line 4 depending on the evaporator intake temperature. The correction variable, i.e. the amount of change to the MCV opening degree of flow channel switching valve 7, is calculated by comparing the temperature information from the evaporator intake temperature sensor with a template for correction. The template, which is for correction depending on the intake temperature, is stored in electronic control device 10. To be more specific, during the first half of the second phase (4-2) of the fourth pattern, the amount of increase or decrease in the intake temperature at each current moment from baseline is calculated first. The baseline is set to the intake temperature sensed when the rotor angle of flow channel switching valve 7 is equal to the second base MCV opening degree. Then, the calculated amount of increase or decrease in intake temperature is compared with the template for correction as illustrated in FIG. 16D, and thereby the correction variable, i.e. the amount of change to the rotor angle of flow channel switching valve 7, depending on the intake temperature is calculated. The calculated correction variable is also temporarily stored in the storage unit of electronic control device 10.

In step S31 of FIG. 15, the correction variables stored in the storage unit are summed up to provide a final correction variable for the rotor angle of flow channel switching valve 7 (referred to as “correction variable for the MCV opening degree” below). Subsequently, the operation proceeds to step S32, in which the above correction variable for the MCV opening degree is added to the second base MCV opening degree to provide a target MCV opening degree. Then, the rotor angle of flow channel switching valve 7 is changed to achieve this target MCV opening degree. In this way, the flow rate through heater line 4 is adjusted based on temperature information from various temperature sensors. This allows maintaining the vehicle interior temperature substantially constant even as temperatures in the environment surrounding the vehicle change.

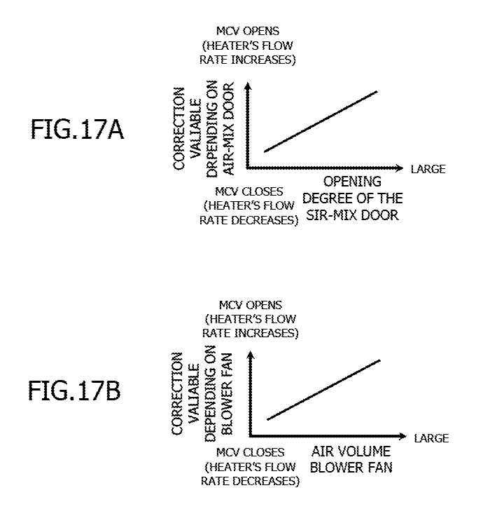

FIG. 17A illustrates a correction variable for the flow rate through heater line 4 depending on the opening degree of the air-mix door. The correction variable, i.e. the amount of change to the MCV opening degree of flow channel switching valve 7, is calculated by comparing opening degree information from an air-mix door sensor with a template for correction. The template, which is for correction depending on the opening degree of the air-mix door, is stored in electronic control device 10. To be more specific, during the first half of the second phase (4-2) of the fourth pattern, the amount of change in the opening degree of the air-mix door at each current moment from baseline is calculated first. The baseline is set to the opening degree of the air-mix door sensed when the rotor angle of flow channel switching valve 7 is equal to the second base MCV opening degree. Then, the calculated amount of change in the opening degree of the air-mix door is compared with the template for correction as illustrated in FIG. 17A, and thereby the correction variable depending on the opening degree of the air-mix door, i.e. the correction variable for the rotor angle of flow channel switching valve 7 (the correction variable for the MCV opening degree), is calculated. The calculated correction variable for the MCV opening degree is added to the second base MCV opening degree to provide a target MCV opening degree. Then, the rotor angle of flow channel switching valve 7 is changed to achieve this target MCV opening degree.

FIG. 17B illustrates a correction variable for the flow rate through heater line 4 depending on the air volume of the blower fan. The correction variable, i.e. the amount of change to the MCV opening degree of flow channel switching valve 7, is calculated by comparing air volume information from a blower fan air volume sensor with a template for correction. The template, which is for correction depending on the air volume of the blower fan, is stored in electronic control device 10. To be more specific, during the first half of the second phase (4-2) of the fourth pattern, the amount of change in the air volume of the blower fan at each current moment from baseline is calculated first. The baseline is set to the air volume of the blower fan sensed when the rotor angle of flow channel switching valve 7 is equal to the second base MCV opening degree. Then, the calculated amount of change in the air volume of the blower fan is compared with the template for correction as illustrated in FIG. 17B, and thereby the correction variable depending on the air volume of the blower fan, i.e. the correction variable for the rotor angle of flow channel switching valve 7 (the correction variable for the MCV opening degree), is calculated. The calculated correction variable for the MCV opening degree is added to the second base MCV opening degree to provide a target MCV opening degree. Then, the rotor angle of flow channel switching valve 7 is changed to achieve this target MCV opening degree.

Although not described above, correction variable(s) for the flow rate through heater line 4 depending on a preset vehicle interior temperature and/or on vehicle-speed air may be used in a similar manner as above. As an alternative, any one of the aforementioned various information pieces on the air conditioning system may be selected and used to calculate the target MCV opening degree, and the opening and closing of flow channel switching valve 7 may be controlled such that the rotor angle of flow channel switching valve 7 achieves this target MCV opening degree.

### REFERENCE SYMBOL LIST

1 internal combustion engine
2 first cooling water channel (radiator line)
3 second cooling water channel (block line)
4 third cooling water channel (heater line)
5 fourth cooling water channel (transmission line or CVT O/W line)
7 flow channel switching valve
8 electric water pump
10 electronic control device (control device)

1.-6. (canceled)

7. A cooling system for an internal combustion engine, comprising:
a flow channel switching valve for switching between a plurality of cooling water channels at least including a heater line for air heating, a block line for cooling an engine block, and a transmission line for an oil warmer of a transmission so as to sequentially open at least one of the plurality of cooling water channels in accordance with a warm-up state of the internal combustion engine; and
a control device for controlling opening and closing of the flow channel switching valve so as to restrict a cooling water distribution rate of the heater line while maintaining a flow rate of cooling water through the transmission line unchanged, when the transmission line opens.

8. The cooling system for the internal combustion engine according to claim 7, wherein the control device maintains the flow rate of cooling water through the transmission line unchanged by adjusting an opening degree of the flow channel switching valve to the heater line and the transmission line.

9. The cooling system for the internal combustion engine according to claim 7, wherein the control device an electric water pump to restrict a discharge flow rate of the electric water pump for supplying cooling water to the plurality of cooling water channels.

10. The cooling system for the internal combustion engine according to claim 7, wherein the control device controls the opening and closing of the flow channel switching valve so as to change a flow rate of cooling water through the heater line based on various information on an air conditioning system including temperature information from temperature sensors installed at different locations in a vehicle.

11. The cooling system for the internal combustion engine according to claim 7, wherein
the flow channel switching valve is a rotary value including a stator having an outlet port and a plurality of inlet ports corresponding to the plurality of cooling water channels, and a rotor having flow channels therein and rotatably fitted in the stator, and
the flow channels of the rotor is formed so as to allow opening ratios of the plurality of inlet ports to change as a rotation angle of the rotor increases such that, when the transmission line opens, the cooling water distribution rate of the heater line is restricted while the flow rate of cooling water through the transmission line is maintained unchanged.

12. A method for controlling a cooling system for an internal combustion engine, the cooling system including a flow channel switching valve for switching between a plurality of cooling water channels at least including a heater line for air heating, a block line for cooling an engine block, and a transmission line for an oil warmer of a transmission so as to sequentially open at least one of the plurality of cooling water channels in accordance with a warm-up state of the internal combustion engine; and a control device, the method causing the control device to control opening and closing of the flow channel switching valve so as to control cooling water distribution rates of the plurality of cooling water channels,
wherein the control device controls the opening and closing of the flow channel switching valve so as to restrict a cooling water distribution rate of the heater line while maintaining a flow rate of cooling water through the transmission line unchanged, when the transmission line opens.
